(19) United States
(12) Patent Application Publication
(10) Pub. No.: US 2015/0350589 A1
(43) Pub. Date: Dec. 3, 2015

(54) A MEMORY CARD AND A METHOD FOR ALLOWING ACCESS TO DIGITAL FILES STORED ON THE MEMORY CARD

(71) Applicant: T-DATA SYSTEMS (S) PTE LTD, Singapore (SG)

(72) Inventor: Joon Yong Wayne TAN, Singapore (SG)

(73) Assignee: T-DATA SYSTEMS (S) PTE LTD, Singapore (SG)

(21) Appl. No.: 14/649,476

(22) PCT Filed: Dec. 7, 2012
(86) PCT No.: PCT/SG2012/000458

§ 371 Date: Jun. 3, 2015

(51) Int. Cl. H04N 5/77; H04N 5/232; G06F 17/30; G06F 3/0484; H04L 29/08

(52) U.S. Cl. CPC H04N 5/772; G06F 3/04847; G06F 3/04842; H04L 67/02; G06F 17/30873; H04N 5/23216

(57) ABSTRACT

There is provided a memory card capable of allowing a plurality of wireless communication devices to access digital files stored on the memory card. The memory card is configured to be electrically connected when inserted in a digital camera which has an inbuilt processor incapable of independently exporting digital files externally of the digital camera. There is also provided a method for allowing access to digital files on a memory card.

### FIELD OF INVENTION

The invention relates to a method for allowing access to digital files stored on a memory card and also to a memory card.

### BACKGROUND

Memory cards are currently a common storage medium for digital data captured using digital cameras. Some of these memory cards have wireless communications capabilities and allow both wireless reception and transmission of digital data.

Wireless communication devices typically communicate with the memory cards with wireless communications capabilities using “apps” running on the wireless communication devices. Without the “apps”, the wireless communication devices are unable to access digital data stored on the memory cards.

Installation of the “apps” is an additional inconvenience for users, and some users are unable to use the “apps” as their wireless communication devices do not have compatible operating systems and/or the users do not wish to incur additional expenses to obtain the “apps”. Furthermore, the “apps” may not be configured to enable all possible features of the memory card, and this may be frustrating to users.

The present invention aims to address the aforementioned issues of the preceding paragraphs.

### SUMMARY

There are currently no “apps” which allow a wireless communication device to have master control functionality over all other connected wireless devices.

In the present invention, there is provided a memory card capable of allowing a plurality of wireless communication devices to access digital files stored on the memory card. The memory card is configured to be electrically connected when inserted in a digital camera which has an inbuilt processor incapable of independently exporting digital files externally of the digital camera.

The memory card includes a central processor for controlling the memory card; a storage module for storing the digital files; and a wireless transceiver module being connected to both the central processor, and the storage module. It is preferable that the central processor is configured to provide a graphical user interface on a web browser on each of the plurality of wireless communication devices, and to receive instructions from a user using the graphical user interface on a first wireless communication device from amongst the plurality of wireless communication devices, whereby the instructions are for granting access to the digital files stored on the storage module by other wireless communication devices.

The first wireless communication device can be designated as a master device, the master device being either first to wirelessly communicate with the memory card, or first to be authenticated by the memory card. Authentication by the memory card includes use of for example, passwords, personal identification numbers, identification of a MAC address of the first wireless communication device which matches a pre-defined MAC addressed stored in the memory card and so forth.

The instructions can be either a first mode of selecting a plurality of the digital files stored on the storage module for viewing on the web browser on the other wireless communication devices or a second mode of selecting a plurality of the digital files stored on the storage module for viewing in a pre-determined order on the web browser on the other wireless communication devices. Furthermore, it is preferable that viewing of the digital files on the web browser of the other wireless communication devices occurs when the first wireless communication device ceases transmission of the instructions to the memory card.

It is preferable that selecting the plurality of the digital files stored on the storage module includes grouping the selected files in a list, the list being accessible to the other wireless communication devices, and the list being stored in a file format which is readable by the web browser of the other wireless communication devices.

In a second aspect, there is provided a method for allowing a plurality of wireless communication devices to access digital files stored on a storage module of a memory card. The memory card is configured to be electrically connected to a digital camera having an inbuilt processor incapable of independently exporting digital files externally of the digital camera.

The method includes providing a graphical user interface on a web browser on each of the plurality of wireless communication devices; and receiving instructions from a user using the graphical user interface on a first wireless communication device from amongst the plurality of wireless communication devices, the instructions being for granting access to the digital files stored on the storage module by other wireless communication devices.

The first wireless communication device can be designated as a master device, the master device being either first to wirelessly communicate with the memory card, or first to be authenticated by the memory card. Authentication by the memory card includes use of for example, passwords, personal identification numbers, identification of a MAC address of the first wireless communication device which matches a pre-defined MAC addressed stored in the memory card and so forth.

The instructions can be either a first mode of selecting a plurality of the digital files stored on the storage module for viewing on the web browser on the other wireless communication devices or a second mode of selecting a plurality of the digital files stored on the storage module for viewing in a pre-determined order on the web browser on the other wireless communication devices. Furthermore, it is preferable that viewing of the digital files on the web browser of the other wireless communication devices occurs when the first wireless communication device ceases transmission of the instructions to the memory card.

It is preferable that selecting the plurality of the digital files stored on the storage module includes grouping the selected files in a list, the list being accessible to the other wireless communication devices, and the list being stored in a file format which is readable by the web browser of the other wireless communication devices.

### DESCRIPTION OF FIGURES

In order that the present invention may be fully understood and readily put into practical effect, there shall now be described by way of non-limitative example only preferred embodiments of the present invention, the description being with reference to the accompanying illustrative figures.

FIG. 1 shows a schematic diagram of a memory card of the present invention when in use.

FIG. 2 shows a process flow of a method of the present invention.

FIG. 3 shows a process flow of a first mode of the method of FIG. 2.

FIG. 4 shows a process flow of a second mode of the method of FIG. 2.

### DESCRIPTION OF PREFERRED EMBODIMENTS

The present invention relates to a memory card which is able to provide a graphical user interface on a web browser of a wireless communications device, so as to allow digital files stored on the memory card to be accessed. A master device wirelessly connected to the memory card is able to control what digital files can be viewed on other wireless communications devices which are also connected to the memory card, and also what digital files are viewed in a pre-determined order on other wireless communications devices which are also connected to the memory card. The digital files in the following description can relate to, for example, image files, music files, video files, and so forth.

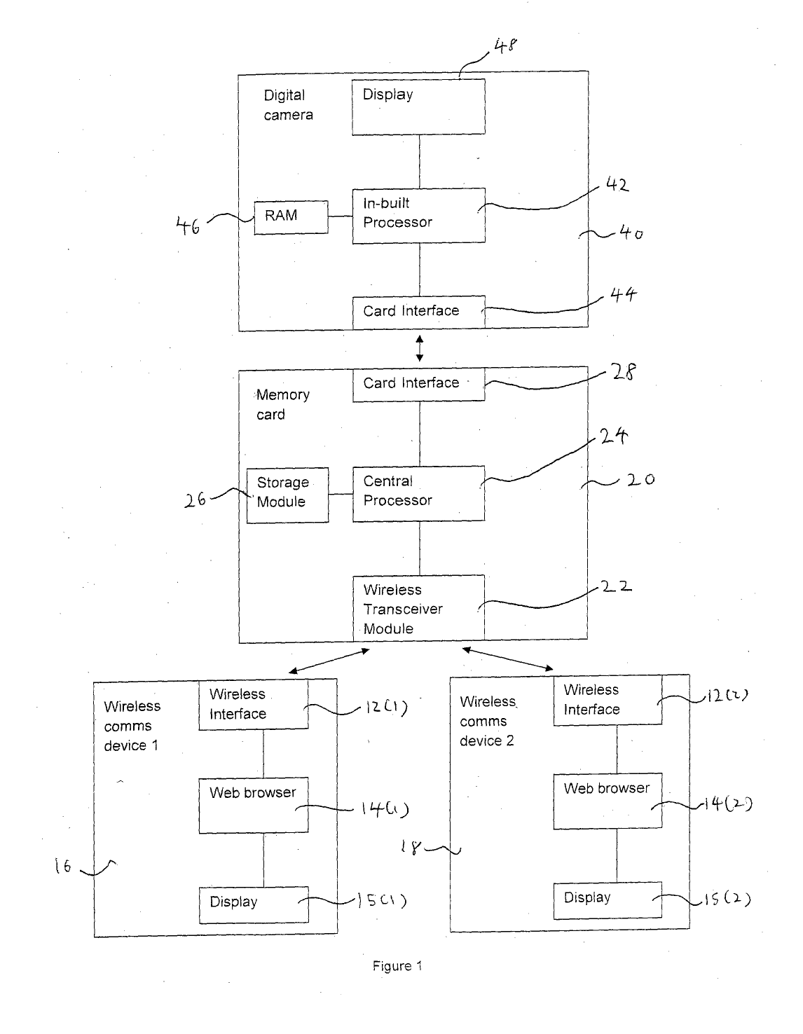

Referring to FIG. 1, there is shown a memory card 20 capable of allowing a plurality of wireless communication devices 16, 18 to access digital files stored on the memory card 20. The memory card 20 is configured to be electrically connected when inserted into a digital camera 40 having an in-built processor 42 incapable of independently exporting digital data externally of the digital camera 40. The digital camera 40 also includes RAM 46 and a display 48. The display 48 of the digital camera 40 may be a touch-sensitive panel and can be used to control the digital camera 40 via a graphical user interface shown on the display 48.

The memory card 20 includes a wireless transceiver module 22 being operably connected to a central processor 24, the central processor 24 being for controlling the memory card 20. The memory card also includes a storage module 26 for storing the digital files. The wireless transceiver module 22 is connected to both the central processor 24 and the storage module 26. The memory card 20 also includes a card interface 28 to communicate with the digital camera 40 card interface 44 such that the memory card 20 is able to operably connect to the digital camera 40. The memory card 20 is powered by the digital camera 40 when the memory card 20 is operably connected to the digital camera.

The plurality of wireless communication devices 16, 18 is able to communicate with the memory card 20 to access digital data stored on the memory card 20. An alphanumeric password may need to be input to the memory card 20 using each of the plurality of wireless communication devices 16, 18 in order to communicate with the memory card 20. Each of the wireless communication devices 16, 18 may be, for example, a mobile phone, a portable computer, a tablet computer and the like. Each of the wireless communications devices 16, 18 includes a wireless interface 12, a web browser 14 and a display 15. The web browser 14 is viewable using the display 15 of each of the wireless communications devices 16, 18. The display 15 may be a touch-sensitive panel.

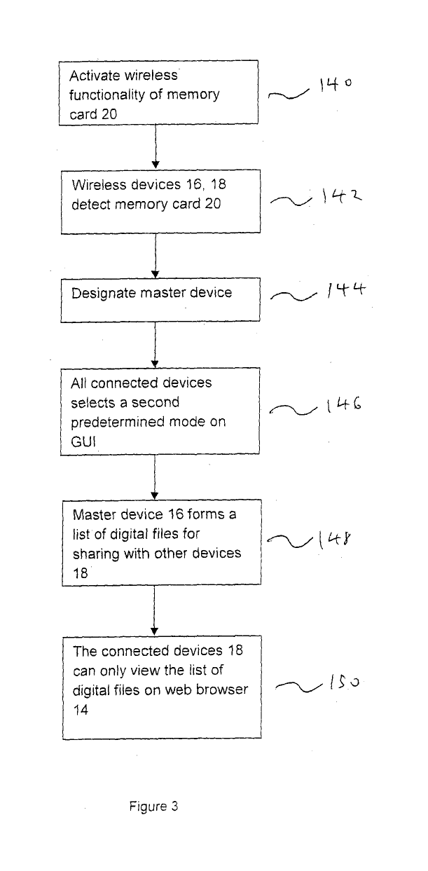

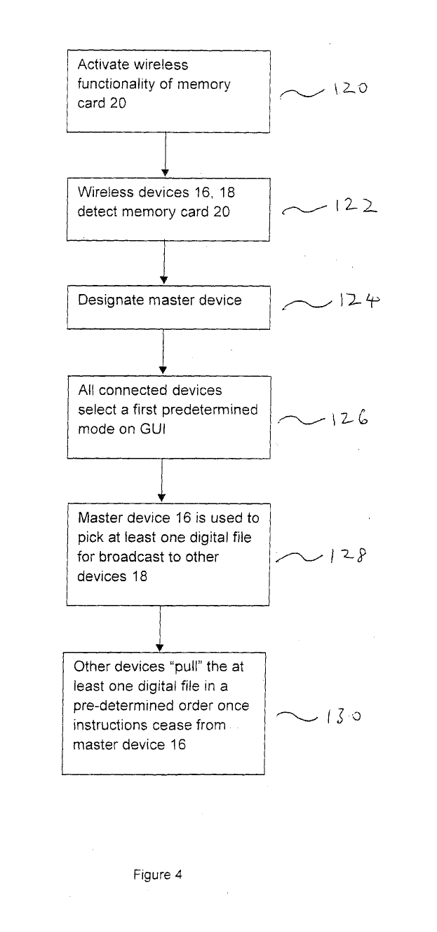

When the wireless communications devices 16, 18 are wirelessly connected to the memory card 20, the central processor 24 is configured to provide a graphical user interface on the web browser 14 on each of the plurality of wireless communication devices 16, 18. The central processor 24 is also configured to receive instructions from a user using the graphical user interface on a first wireless communication device 16, the instructions being for granting access to the digital files stored on the storage module 26 by other wireless communication devices 18. The instructions are a first mode of selecting a plurality of the digital files stored on the storage module 26 for viewing on the web browser 14 on the other wireless communication devices 18, or a second mode of selecting a plurality of the digital files stored on the storage module 26 for viewing in a pre-determined order on the web browser 14 on the other wireless communication devices 18. It should be appreciated that the pre-determined order for viewing the digital files can be conceived “on-the-fly” by the user of the first wireless communication device 16. Further details of the first and second modes will be provided when describing FIGS. 3 and 4.

The first wireless communication device 16 is designated as a master device, the master device being first from amongst the plurality of wireless communication devices 18 to wirelessly communicate with the memory card 20, and/or first from amongst the plurality of wireless communication devices 18 to be authenticated by the memory card 20. It should be appreciated that the first from amongst the plurality of wireless communication devices 18 to wirelessly communicate with the memory card 20 is used to mean at every instance that the memory card 20 is powered up. Authentication by the memory card 20 can be carried out using known techniques involving use of, for example, passwords, personal identification numbers, identification of a MAC address of the first wireless communication device 16 which matches a pre-defined MAC addressed stored in the memory card, and so forth.

When the user of the master device (first wireless communication device 16) selects at least one of the digital files stored on the storage module 26, the selected digital files are grouped in a list. Content in the list is accessible to the other wireless communication devices 18. The list can be stored in a file format which is readable by the web browser 14 of the other wireless communication devices 18. Viewing of the selected digital files on the web browser 14 on other wireless communication devices 18 occurs when the first wireless communication device 16 ceases transmission of the instructions to the memory card 20. This is so that the user of the master device (first wireless communication device 16) is able to carry out the intended task(s). It is possible to view the selected digital files on the web browser 14 on other wireless communication devices 18 before the first wireless communication device 16 ceases transmission of the instructions to the memory card 20 if the other wireless communication devices 18 are already able to access a prior list from the memory card 20.

It should be appreciated that content stored in the storage module 26 of the memory card 20 is accessible in a manner which is determined by the user of the master device. Thus, the user of the master device is able to control what digital files are viewable on the web browsers 14 of the other wireless communication devices 18 and can even control an order which the digital files are viewed on the web browsers 14 of the other wireless communication devices 18. The possibility to control what is viewable on the web browsers 14 of the other wireless communication devices 18 without installing “apps” in each wireless communication device and without having to alter an interface of the digital camera 40 is convenient.

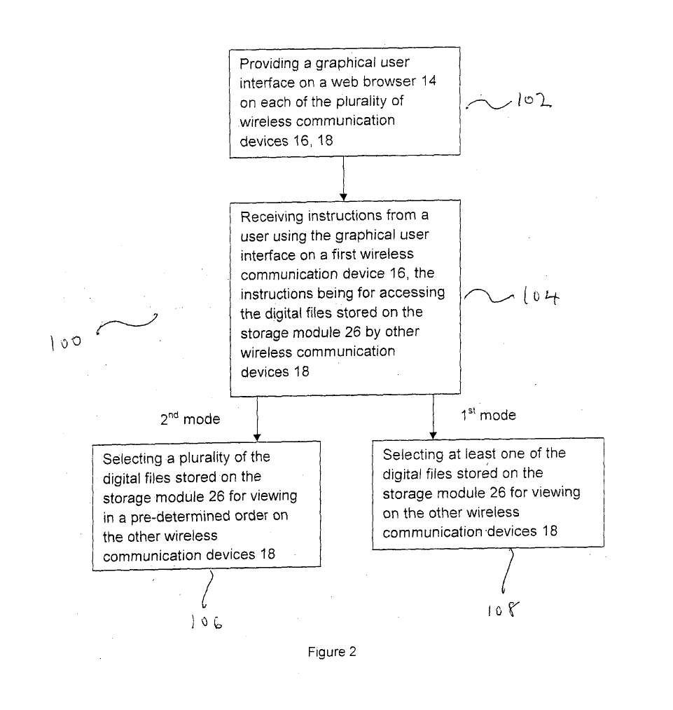

Referring to FIG. 2, there is shown a method 100 for allowing a plurality of wireless communication devices 16, 18 to access digital files stored on a storage module 26 of a memory card 20 as described in the preceding paragraphs. An alphanumeric password may need to be input to the memory card 20 using each of the plurality of wireless communication devices 16, 18 in order to communicate with the memory card 20. The method 100 includes providing a graphical user interface on a web browser 14 on each of the plurality of wireless communication devices 16, 18 (102). Subsequently, the method 100 includes receiving instructions from a user using the graphical user interface on a first wireless communication device 16, the instructions being for accessing the digital files stored on the storage module 26 of the memory card 20 by other wireless communication devices 18 (104).

The instructions are either a first mode of selecting a plurality of the digital files stored on the storage module 26 for viewing in a pre-determined order on the web browser 14 on the other wireless communication devices 18 (108), or a second mode of selecting at least one of the digital files stored on the storage module 26 for viewing on the web browser 14 on the other wireless communication devices 18 (106). It should be appreciated that the pre-determined order for viewing the digital files can be conceived “on-the-fly” by the user of the first wireless communication device 16. Further details of the first and second modes will be provided when describing FIGS. 3 and 4.

The first wireless communication device 16 is designated as a master device, the master device being first from amongst the plurality of wireless communication devices 18 to wirelessly communicate with the memory card 20, and/or first from amongst the plurality of wireless communication devices 18 to be authenticated by the memory card 20. It should be appreciated that the first from amongst the plurality of wireless communication devices 18 to wirelessly communicate with the memory card 20 is used to mean at every instance that the memory card 20 is powered up. Authentication by the memory card 20 can be carried out using known techniques involving use of, for example, passwords, personal identification numbers, identification of a MAC address of the first wireless communication device 16 which matches a pre-defined MAC addressed stored in the memory card, and so forth.

In the method 100, when the user of the master device (first wireless communication device 16) selects at least one of the digital files stored on the storage module 26, the selected digital files are grouped in a list. The list can be stored in a file format which is readable by the web browser 14 of the other wireless communication devices 18. Content in the list is accessible to the other wireless communication devices 18. Viewing of the selected digital files on the web browser 14 on the other wireless communication devices 18 occurs when the first wireless communication device 16 ceases transmission of the instructions to the memory card. This is so that the user of the master device (first wireless communication device 16) is able to carry out the intended task(s). It is possible to view the selected digital files on the web browser 14 on other wireless communication devices 18 before the first wireless communication device 16 ceases transmission of the instructions to the memory card 20 if the other wireless communication devices 18 are already able to access a prior list from the memory card 20.

It should be appreciated that during use of the method 100, content stored in the storage module 26 of the memory card 20 is accessible in a manner which is determined by the user of the master device. Thus, the user of the master device is able to control what digital files are viewable on the web browsers 14 of the other wireless communication devices 18 and can even control an order which the digital files are viewed on the web browsers 14 of the other wireless communication devices 18. The possibility to control what is viewable on the web browsers 14 of the other wireless communication devices 18 without installing “apps” in each wireless communication device and without having to alter an interface of the digital camera 40 is convenient.

The first mode will now be described with reference to FIG. 3. The first mode relates to selecting at least one of the digital files stored on the storage module 26 for viewing on the web browser 14 on the other wireless communication devices 18. Firstly, a wireless functionality of the memory card 20 is activated (140). Wireless communication devices 16, 18 then detect the memory card 20 (142). An alphanumeric password may need to be input to the memory card 20 using each of the plurality of wireless communication devices 16, 18 in order to communicate with the memory card 20.

A master device is then designated amongst connected wireless communication devices 16, 18 (144). The master device 16 is either first to wirelessly communicate with the memory card 20, or first to be authenticated by the memory card 20. Authentication by the memory card 20 can be carried out using known techniques involving use of, for example, passwords, personal identification numbers, identification of a MAC address of the first wireless communication device 16 which matches a pre-defined MAC addressed stored in the memory card, and so forth.

All connected wireless communication devices 16, 18 then selects a second pre-determined mode on a graphical user interface viewable on a web browser 14 of the connected wireless communication devices 16, 18 (146). Subsequently, the master device 16 is used to pick at least one digital file from the storage module 26 in the memory card 20, the picked digital files forming a list for sharing with other wireless communication devices 18 (148). The other wireless communication devices 18 can then view the list of digital files on the web browser 14 once instructions cease transmitting from the master device 16 (150). It is possible to view the selected digital files on the web browser 14 on other wireless communication devices 18 before the first wireless communication device 16 ceases transmission of the instructions to the memory card 20 if the other wireless communication devices 18 are already able to access a prior list from the memory card 20.

The second mode will now be described with reference to FIG. 4. The second mode relates to selecting a plurality of the digital files stored on the storage module for viewing in a pre-determined order on the web browser 14 on the other wireless communication devices 18. Firstly, a wireless functionality of the memory card 20 is activated (120). Wireless communication devices 16, 18 then detect the memory card 20 (122). An alphanumeric password may need to be input to the memory card 20 using each of the plurality of wireless communication devices 16, 18 in order to communicate with the memory card 20.

A master device is then designated amongst connected wireless communication devices 16, 18 (124). The master device 16 is either first to wirelessly communicate with the memory card 20, or first to be authenticated by the memory card 20. Authentication by the memory card 20 can be carried out using known techniques involving use of, for example, passwords, personal identification numbers, identification of a MAC address of the first wireless communication device 16 which matches a pre-defined MAC addressed stored in the memory card, and so forth.

All connected wireless communication devices 16, 18 then selects a first pre-determined mode on a graphical user interface viewable on a web browser 14 of the connected wireless communication devices 16, 18 (126). Subsequently, the master device 16 is used to pick at least one digital file from the storage module 26 in the memory card 20 for broadcast to other wireless communication devices 18 (128). The other wireless communication devices 18 then “pull” the at least one digital file once instructions cease transmitting from the master device 16 (130).

Whilst there has been described in the foregoing description preferred embodiments of the present invention, it will be understood by those skilled in the technology concerned that many variations or modifications in details of design or construction may be made without departing from the present invention.

1. A memory card capable of allowing a plurality of wireless communication devices to access digital files stored on the memory card, the memory card being configured to be electrically connected when inserted in a digital camera having an inbuilt processor incapable of independently exporting digital files externally of the digital camera, the memory card including:
a central processor for controlling the memory card;
a storage module for storing the digital files; and
a wireless transceiver module being connected to both the central processor, and the storage module,
wherein the central processor is configured to provide a graphical user interface on a web browser on each of the plurality of wireless communication devices, and to receive instructions from a user using the graphical user interface on a first wireless communication device from amongst the plurality of wireless communication devices, the instructions being for granting access to the digital files stored on the storage module by other wireless communication devices.

2. The memory card of claim 1, wherein the first wireless communication device is designated as a master device, the master device being either first from amongst the plurality of wireless communication devices to wirelessly communicate with the memory card, or first from amongst the plurality of wireless communication devices to be authenticated by the memory card.

3. The memory card of claim 2, wherein authentication by the memory card includes use of at least one of: passwords, personal identification numbers, and identification of a MAC address of the first wireless communication device which matches a pre-defined MAC addressed stored in the memory card.

4. The memory card of claim 1, wherein the instructions are a first mode of selecting a plurality of the digital files stored on the storage module for viewing on the web browser on the other wireless communication devices.

5. The memory card of claim 4, wherein the instructions are a second mode of selecting a plurality of the digital files stored on the storage module for viewing in a pre-determined order on the web browser on the other wireless communication devices.

6. The memory card of claim 4, wherein selecting the plurality of the digital files stored on the storage module includes grouping the selected files in a list, the list being accessible to the other wireless communication devices.

7. The memory card of claim 6, wherein the list is stored in a file format which is readable by the web browser of the other wireless communication devices.

8. The memory card of claim 4, wherein viewing of the digital files on the web browser of the other wireless communication devices occurs when the first wireless communication device ceases transmission of the instructions to the memory card.

9. A method for allowing a plurality of wireless communication devices to access digital files stored on a storage module of a memory card, the memory card being configured to be electrically connected to a digital camera having an inbuilt processor incapable of independently exporting digital files externally of the digital camera, the method including;
providing a graphical user interface on a web browser on each of the plurality of wireless communication devices; and
receiving instructions from a user using the graphical user interface on a first wireless communication device from amongst the plurality of wireless communication devices, the instructions being for granting access to the digital files stored on the storage module by other wireless communication devices.

10. The method of claim 9, wherein the first from amongst the plurality of wireless communication devices is designated as a master device, the master device being either first from amongst the plurality of wireless communication devices to wirelessly communicate with the memory card, or first from amongst the plurality of wireless communication devices to be authenticated by the memory card.

11. The method of claim 10, wherein authentication by the memory card includes use of at least one of: passwords, personal identification numbers, and identification of a MAC address of the first wireless communication device which matches a pre-defined MAC addressed stored in the memory card.

12. The method of claim 9, wherein the instructions are a first mode of selecting a plurality of the digital files stored on the storage module for viewing on the web browser on the other wireless communication devices.

13. The method of claim 12, wherein the instructions are a second mode of selecting a plurality of the digital files stored on the storage module for viewing in a pre-determined order on the web browser on the other wireless communication devices.

14. The method of claim 12, wherein selecting at least one of the digital files stored on the storage module includes grouping the selected files in a list, the list being accessible to the other wireless communication devices.

15. The method of claim 14, wherein the list is stored in a file format which is readable by the web browser of the other wireless communication devices.

16. The method of claim 12, wherein viewing of the digital files on the web browser on the other wireless communication devices occurs when the first wireless communication device ceases transmission of the instructions to the memory card.
